(19) United States
(12) Patent Application Publication
(10) Pub. No.: US 2006/0178889 A1
(43) Pub. Date: Aug. 10, 2006

(54) Method and system for performing electronic commerce

(76) Inventor: Peter R. Benson, Malibu, CA (US)

Correspondence Address: David M Carter;Carter Deluca Farrell & Schmidt, Suite 225, 445 Broad Hollow Road, Melville, NY, 11747, US

(21) Appl. No.: 10/381,086

(22) PCT Filed: Sep. 25, 2001
(86) PCT No.: PCT/US01/29927

§ 371 Date: Mar. 10, 2005

Related U.S. Application Data
(60) Provisional application No. 60/235,031, filed on Sep. 25, 2000.

(51) Int. Cl. G06Q 99/00; G06Q 30/00; G06Q 40/00

(52) U.S. Cl. 705/1; 705/26; 705/39

(57) ABSTRACT

The present invention relates generally to electronic commerce, and more particularly, to a method and system for performing electronic commerce over the Internet.

### PRIORITY

This application claims priority to an application entitled “METHOD AND SYSTEM FOR PERFORMING ELECTRONIC COMMERCE” filed in the United States Patent and Trademark Office on Sept. 25, 2000 and assigned Ser. No. 60/235,031, the contents of which are hereby incorporated by reference.

### BACKGROUND OF THE INVENTION

1. Field of the Invention

The present invention relates generally to electronic commerce, and more particularly, to a method and system for performing electronic commerce over the Internet.

2. Description of the Related Art

Since HTTP's (Hypertext Transfer Protocol) introduction, the Internet has opened many avenues for electronic commerce. For example, vendors around the world can now offer product catalogs on www (World Wide Web) pages, thus reaching not just their local potential customers but also potential customers at remote locations around the world. However, such vendors have no guarantee that maintaining such a www page will increase business. Plainly, before business can increase, potential customers must be able to find a vendor's www page, e.g., potential customers must first know that a vendor exists.

Conventional methods of finding vendors on the Internet invariably involve use of search engines. Search engines are web applications that search for web pages matching a certain criterion. For example, users use search engines daily to find web pages that store information on subjects like sports, art, technology and science. A search engine is actually a set of programs accessible at a network site within a network, for example a local area network (LAN) at a company or the Internet and World Wide Web. One program, called a “robot” or “spider,” pre-traverses a network in search of documents and builds large index files of keywords found in the documents.

A user of the search engine formulates a query comprising one or more keywords and submits the query to another program of the search engine. In response, the search engine inspects its own index files and displays a list of documents that match the search query, typically as hyperlinks. When a user activates one of the hyperlinks to see the information contained in the document, the user exits the site of the search engine and terminates the search process.

In the www's infancy, few search engines existed. Today, they number in the tens of thousands with most free for public use, such as Alta Vista, Excite, Google, HotBot, Lycos and Yahoo!. Of these, some—like those listed above—purport to search the entire www, while others are more specialized and cover specific industries only. Finally, the majority search through just a single web site, usually of a large corporate enterprise, such as ibm.com.

Search engines, like most database applications, apply traditional search-and-retrieve mechanisms. However, search engines are at a disadvantage when compared to desktop or mainframe applications, chiefly due to the www's structure. To appreciate the difference, consider this: most corporate databases stringently adhere to a specific structure, a structure that database designers and administrators establish prior to entering data. This structure serves as a roadmap “written in stone”; all data must conform to it without exception. Consequently, developers can easily search and retrieve because they structure their queries based on the database architecture.

The web works differently and is effectively the “wild west” of databases. Every web site is organized differently and these deviations, no matter how slight, can make transactional search and retrieval approaches more difficult. This is partially due to the web's underlying technologies. Web developers basically cannot perform logical web indexing. Hypertext Markup Language (HTML)—what web pages consist of—offers no way to differentiate one data element from another data element. For example, while one can use HTML to visually label a list item as an address element, one cannot use it to logically or programmatically label it. Hence, while a user can visually recognize an address element as such, a machine cannot comprehend it in this way.

This limits automated web indexing to regular expression searches and similar procedures. Here, lexical scanners examine thousands of lines of HTML looking for a matching text pattern. Unfortunately, the indexing procedures of such search engines are insufficient for the purpose of finding web sites associated with potential vendors, rather than, e.g., web sites associated with a particular manufacturer who is not a vendor. Although users adept in Boolean expressions (logical operators OR, AND or NOT) can reap a more incisive result, even when one uses such measures, a search for “tractors” or “office desks” can return tens of thousands of links. Thus, generating a viable list of vendors for tractors or other products/services is impractical.

Moreover, other problems exist, even if the query search returns only a limited number of web site links, i.e., URLs, etc. One problem is that a user must venture forward to investigate these links, one at a time. The user cannot guarantee that the limited number of links will be valid. Some studies suggest that as many as three out of every ten links will return a 404 error (i.e., Page Not Found error).

Further, even if the links lead to valid pages, the user cannot anticipate the purpose, content, or structure of those web site pages. Thus, the user has no guarantee that such links will be product specifications, price catalogs, or pages designed to be read by automated procurement systems. With the increasing complexity of web syntax, even if the links are valid and the content is meaningful, the user has no guarantee that his clients will be able to interact with, read, or otherwise use the information in any meaningful way.

Therefore, before Internet-based global (and automated) electronic commerce can fully bloom, we must first offer buyers and suppliers, i.e., vendors, the ability to ascertain six things:

1. Where (on the network) a vendor's information is stored.

2. What type of network resource (or page) the vendor maintains.

3. In what format the vendor stores its information.

4. In what language the vendor creates its content.

5. The vendor's geographical location.

6. The vendor's purported online trading identity.

### SUMMARY OF THE INVENTION

Accordingly, it is an aspect of the present invention to provide a method and system for performing electronic commerce which overcome the disadvantages of the prior art methods and systems.

It is another aspect of the present invention to provide a protocol that will simplify and automate many electronic commerce tasks, including procurement, purchasing, and the mining and qualifying of potential online trading partners.

According to the present invention, a system for performing electronic commerce is provided. The system includes a query client, such as a terminal, coupled to a network, e.g., the Internet, for searching online trading vendor information; and a global business registry including trading vendor information tagged with at least one unique identifier, e.g., a global business identifier and/or a global location identifier. Additionally, a particular trading vendor's information is associated with at least a Uniform Resource Locator (URL), a URL type identifier, a URL format identifier, and a language translation identifier to ensure that the vendor's information is compatible with the query client. The global business registry is essentially a database for storing and receiving high-quality, low-level infrastructure data foundational to all electronic commerce transactions.

According to another aspect of the present invention, a method for performing electronic commerce is also provided. The method includes the steps of receiving a query including at least one code-specific or predetermined value over a network, e.g., the Internet; querying a database which includes formatted information and is connected to the network to find at least one result related to the code-specific or pre-determined value; and returning at least one found result to a client associated with the query. The at least one code-specific or pre-determined value can be one or more of the following: a sequence identifier code, a latitude and longitude location value, a URL type identifier, a URL format identifier, and a language translation identifier.

Additionally, the method provides for creating and appending the database, i.e., the global business registry by receiving information from an online trading vendor relating to the vendor's products and/or services; formatting the information into a standard file format including at least one data segment; tagging the at least one data segment with a code; and storing the tagged data segment in the database. Preferably, the code used to tag the vendor information is the Universal Standard Products and Services Classification (UNSPSC) code.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a method for performing electronic commerce according to the present invention;

FIG. 2 is a flowchart illustrating a method for tagging supplier information according to the present invention;

FIG. 3 is a block diagram illustrating a single database record according to the present invention;

FIG. 4 is a flowchart illustrating a method for finding vendor information according to the present invention; and

FIG. 5 is a block diagram illustrating a system for performing electronic commerce according to the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

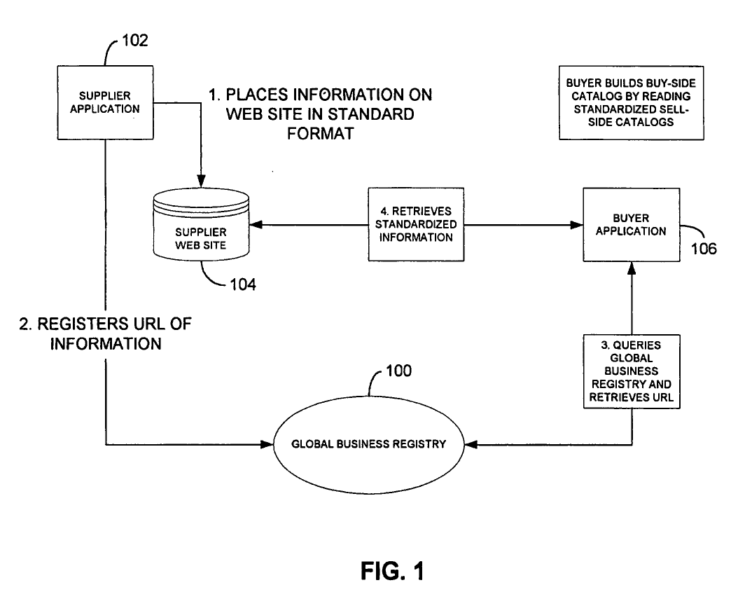

Referring to FIG. 1, the method and system of the present invention allow a buyer 106 to search a network for potential vendors and create Buy-Side catalogs and/or place orders by reading Sell-Side catalogs from a vendor or a supplier's web site 104. The buyer 106 evaluates the supplier's web site 104 and controls what is incorporated in the Buy-Side catalog. The supplier 102 can control access to the data on its website 104.

From a technology point of view it is efficient for the buyer 106 to pull data when it is needed (i.e., update Buy-Side catalog: Office supplies on Monday, Office furniture on Tuesday, Fasteners on Wednesday, etc.) rather than have to receive input from the supplier 102 when the supplier 102 wants to send it, e.g., via e-mail. From a supplier implementation perspective, it is irrelevant whether the supplier 102 sends data to the buyer 106 or the buyer 106 pulls it from the suppliers web site 104.

With continued reference to FIG. 1, the inventive method is implemented by creating a global business registry (GBR) 100. The global business registry 100 is a central location for the supplier 102 to post, and for the buyer 106 to search, high-quality, low-level infrastructure data. The global business registry 100 operates under a whosells protocol developed by ResolveNet (IOM) Limited and which is a protocol for validating, cataloging, searching, and retrieving updated information in real-time. Data is validated and cataloged the moment it is entered and immediately following any administrative editing on the supplier's part. Cataloging actually involves breaking down all of the supplier's low-level data, validating it, and assigning each element the appropriate standardized tag, or code, that identifies each data type. The tagged data elements are then stored in the global business registry 100.

That is, to build the database of the global business registry 100, information supplied by online trading vendors, or suppliers, is tagged. The tagging process adds standard code tags and globally unique identifiers to the supplier's catalogs, address files, transactional and legacy data to improve the data quality and usability in performing automated electronic commerce.

By utilizing the whosells protocol, the buyer 106 then searches the global business registry 100, and retrieves results. The results retrieved are updated real-time and accurate, as only the supplier 102 himself has control over the content displayed on his web site 104. Because the global business registry 100 is built on open standards, and specifically to support “Open Procurement” (the process of analyzing all possible suppliers before selecting the most appropriate), it is inherently a central registry for accessing by a multitude of e-marketplaces, procurement portals, and information exchanges. The open source code of the global business registry 100 affords anyone the ability to incorporate the search protocols on their website or within software applications.

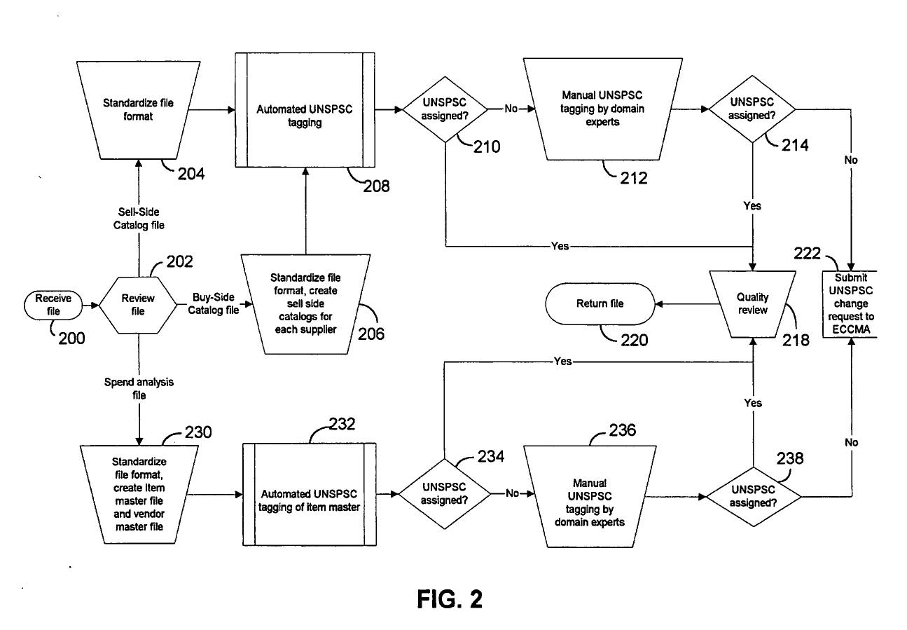

FIG. 2 is a flowchart illustrating a tagging procedure in accordance with the present invention. Specifically, FIG. 2 illustrates a tagging procedure for tagging a supplier's information file with the UNSPSC code. After receiving an information file from a supplier or vendor at step 200, the file is reviewed at step 202 to determine whether more information is needed to satisfactorily tag the file. After the file is reviewed, the information is formatted into a standardize file format to be received into a Sell-Side and a Buy-Side catalog file at steps 204 and 206, respectively. The catalog files are then sent to a computer assisted classification system for automated tagging with the UNSPSC code at step 208. If the file is satisfactorily tagged as determined by step 210, the file undergoes a quality review at step 218 and is returned at step 220 to be used at the supplier's web site 104. If the file was not satisfactorily tagged as determined by step 210, a domain expert will attempt to manually tag the file at step 212. If the file is satisfactorily tagged as determined by step 214, it is passed onto a quality review at step 218 as described above. Otherwise, if a satisfactory code cannot be found, a change request can be submitted to the code's governing body at step 222 to initiate a code more suitable for the particular vendor's product or service. The change request process is described in PCT Patent Application No. PCT/US01/22496 entitled “METHOD AND SYSTEM FOR MANAGING A CODE” filed on Jul. 18, 2001 by Peter R. Benson, the contents of which are incorporated by reference. Further, when the file is received at step 220 and reviewed at step 202, it may be processed in a spend analysis file in steps 230 to 238 in a way similar to the process described above for the Sell-Side catalog file. By coding the file, the buyer can see how much or how little they spend on a commodity and from which particular vendor or supplier the commodity comes from.

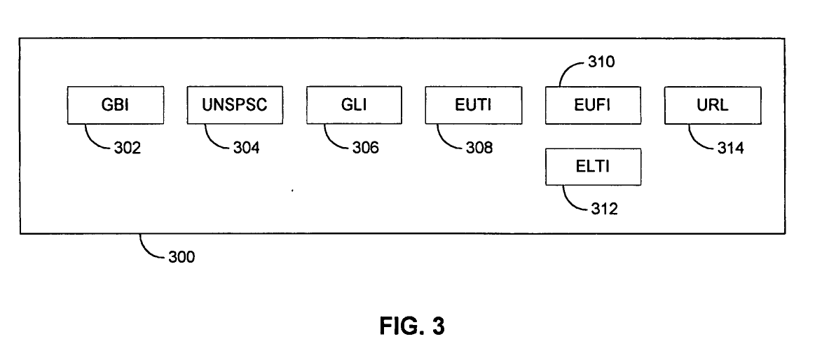

The tagging process of FIG. 2 is repeated to tag the file using additional codes besides the UNSPSC code to further tag the supplier's files with unique code/parameter identifiers. An example of a single tagged record 300 is shown in FIG. 3. Briefly, the record 300 includes the following data segments: a global business identifier (GBI) 302, the UNSPSC code 304, a global location identifier (GLI) 306, a URL type identifier (EUTI) 308, a URL format identifier (EUFI) 310, a URL language translation identifier (ELTI) 312 and a Uniform Resource Locator (URL) 314. Each data segment will be described in more detail below by the way of an example.

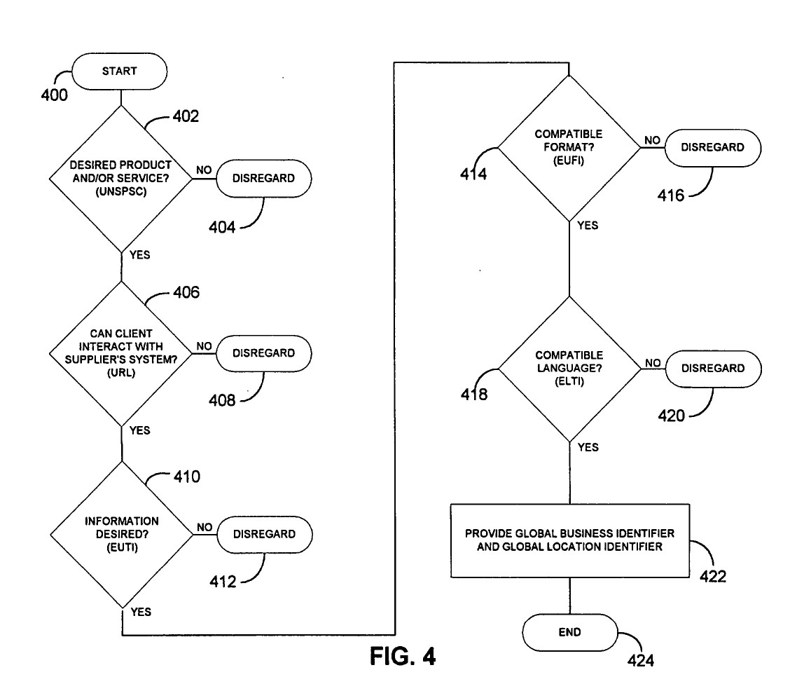

The global business registry 100 is then assembled with a multitude of records 300 to assist buyers in finding potential suppliers. Referring to FIG. 4, a search for potential suppliers is conducted by interacting with the global business registry 100. To begin the search, a client, i.e., a buyer, enters a query relating to a specific product or service desired at step 400. According to the method of the present invention, the data segments of the tagged records 300 are searched for matching results. First, the method ensures that returned vendors sell the desired product or service the buyer seeks at step 402. This alone is a tremendous improvement in relevance over standard web searches.

Next, the method determines if the desired information is located at a given URL at step 406. This does not merely specify the vendor's online location, but gives clues as to whether the buyer can generally interact with the vendor's system. For instance, a URL could be merely an e-mail address or File Transfer Protocol (FTP) site. If so, the chances that the specified vendor supports automated procurement is slim: an e-mail address is merely a contact point, and an FTP site is archival.

Next, the method determines the supplier's URL type identifier (EUTI) at step 410. This specifies the URL's purpose. If a buyer is seeking price information, he naturally wants a price catalog type EUTI. If a returned supplier's EUTI is simply a home page, the buyer might well disqualify that vendor for the purposes of the instant search. If, on the other hand, the EUTI type reported is a price catalog, the search can continue.

Then, the method of the present invention checks the URL's format type identifier (EUFI) at step 414. From this, one will learn what format types the vendor's site supports. For example, suppose that one is seeking financial data and their system reads XBRL (the Extensible Business Reporting Language). The method described allows one to filter out all potential trading partners that do not return a EUFI XBRL identifier.

Next, the method verifies the language translation identifier (ELTI) at step 418. From this, one can learn what languages the vendor's site supports. For example, suppose that a buyer is seeking only English content. The buyer is enabled to filter out all potential trading partners whose content is not in English.

It is to be understood that if any of the above-mentioned steps incurs an incompatible data segment, the current record 300 being searched will be disregarded at steps 404, 408, 412, 416 or 420 and other available records 300 will be analyzed by the inventive method.

Referring back to FIG. 4, if a vendor meets all of the buyers needs (the correct URL type, page type, format type, and language), the buyer will be provided with more information, starting with whom the specified vendor is and where they are located. The method provides this information through a global business identifier (GBI) and a global location identifier (GLI) at step 422. The GBI can be used with an identify protocol to access all the identifiers of a business (Legal name, main telephone number, DUNS number, TIN, etc.) and the GLI can be used with a geolocate protocol to identify the exact or approximate longitude and latitude as well physical address information of the business entity. The method then terminates at step 424.

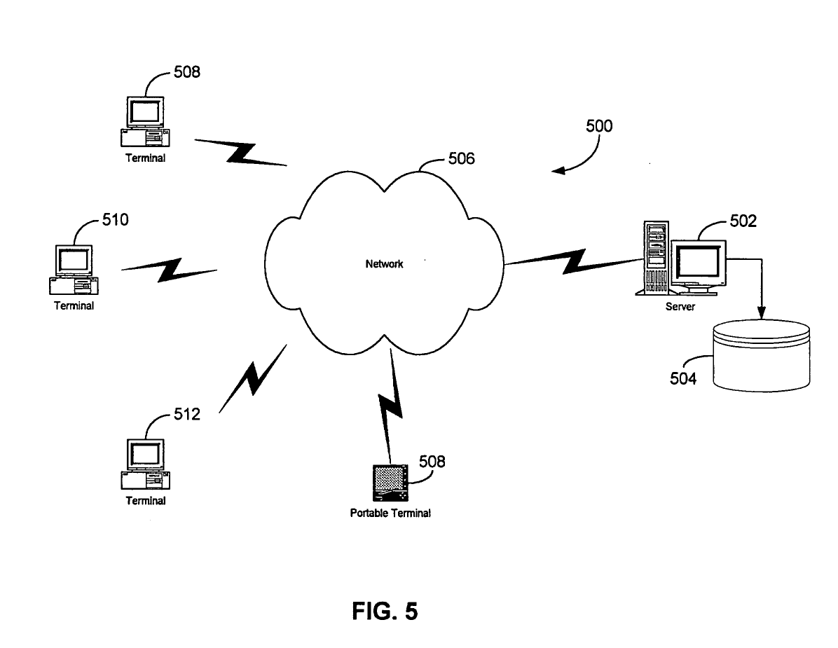

By way of example as shown in FIG. 5, the following is a description of a system 500 embodying the method described above designed to implement the open standards established by the Electronic Commerce Code Management Association (ECCMA).

The system 500 employs the whosells protocol designed to facilitate electronic commerce in general and specifically open procurement. It includes an interactive, distributed database 504, based upon the client-server model. Users can retrieve information in one or more ways, such as over the network 506. For the Internet community at large, such information can be retrieved by conventional means with any HTTP client. The information can also be reached from a CLI (Command Line Interface) on both the UNIX and Windows NT platforms. Herein below, only the CLI server and client specification are described.

whosells Server

The WHOSELLS server 502 is an HTTP based query/response server running on http://whosells.resolvenet.net. The server 502 provides directory services to Internet users via a URL-based query and response. The server 502 reports data that online trading entities wish to publish to facilitate and engage in open procurement.

Terminologies and Notation

In this document, the following acronyms appear:

ECCMA—Electronic Commerce Code Management Association

EGCI—ECCMA Global Commodity Identifier

BTI—ECCMA Business Type Identifier

EUTI—ECCMA URL Type Identifier

EUFI—ECCMA URL Format Identifier

ELTI—ECCMA Language Translation Identifier

GBI—Global Business Identifier

GLI—Global Location Identifier

LAT—Latitude

LONG—Longitude

N\L—Newline

SQL—Structured Query Language

UNSPSC—Universal Standard Products and Services Classification

Sequence Identifier—A numeric value that identifies a specific code record in any one of the ECCMA Schemas (i.e., EGCI, EUTI, EUFI, ELTI are all valid Sequence Identifiers in their respective schemas).

WHOSELLS Service Description

The server 502 is designed to facilitate open procurement and electronic commerce. It is a URL based web page with input parameters specified as part of the URL. The server 502 accepts thirteen arguments in its query string from any client 508 or web browser:
[egci.bti] [lat] [long] [city] [state] [country] [euti] [eufi] [elti] [distunit] [maxdist] [maxrec] [skip]

The following are descriptions of each input argument:

[egci.bti]—The EGCI is The ECCMA Global Commodity Identifier, a valid Sequence Identifier from The Universal Standard Products and Services Classification (UNSPSC). The UNSPSC coding system is an open, hierarchical, global electronic commerce standard that provides a logical framework for classifying goods and services. The BTI is the ECCMA Business Type Identifier, a Valid Sequence Identifier from the UNSPSC that identifies the type of business (i.e. wholesale, retail, manufacturer). The BTI is appended to the EGCI and the EGCI/BTI combination consists of two six-digit numbers separated by a dot (i.e. 123456.123456). The egci.bti argument thus identifies the product or service and the type of business you seek. It is a REQUIRED argument.

[lat]—The user's latitude, which is a point that identities the angular distance north or south of the earth's equator, measured in degrees along a meridian. This, coupled with the user's longitude, identifies the user's location. The user expresses latitude in decimal notation (e.g., 33.58). If the user desires a search based on latitude and longitude, then [lat] is a REQUIRED argument together with [long] when a [city], [state] and [country] combination is not passed.

[long]—The user's longitude, a point that identifies the angular distance on the earth's surface, measured east or west from the prime meridian at Greenwich, England, to the meridian passing through a position, expressed in degrees (or hours), minutes, and seconds. This, coupled with the user's latitude, identifies the user's location. The user expresses longitude in decimal notation (e.g., 85.85). If the user desires a search based on latitude and longitude, then [long] is a REQUIRED argument together with [lat] when a [city], [state] and country combination is not passed.

[city]—The user's city. If the user desires a geographical search, then [city] is a REQUIRED argument together with [country] (and [state] if [country] is US) when a [lat] and [long] pair is not passed.

[state]—The user's state. If the user is doing a geographical search, and the [country] value passed is US, then [state] is a REQUIRED argument along with [city] when a [lat] and [long] pair is not passed.

[country]—The user's country. If the user is doing a geographical search, then [country] is a REQUIRED argument together with [city] (and [state] if [country] is US]) when a [lat] and [long] pair is not passed. If [city] and [state] are passed, without a value for [country] then [country] defaults to US.

Note: The arguments listed as REQUIRED with respect to location are only truly REQUIRED if the user is concerned with the location. If not, then all of the location arguments (lat, long, city, state, country, distunit and maxdist) MAY be omitted.

[euti]—The ECCMA URL Type Identifier, a valid Sequence Identifier from the ECCMA URL Type Schema (EUTS) that identifies the trading partner's URL type, e.g., home page, product catalog, price catalog, and is a OPTIONAL argument.

[eufi]—The ECCMA URL Format Identifier, a valid Sequence Identifier from the ECCMA URL Format Schema (EUFS) that identifies your desired data types, or, what data types that your procurement client supports. EUFIs consist of both high-level, generic data types (HTML, XML, EDI, etc.) as well as industry-specific types e.g., Ariba Catalog, or Commerce One's XML Common Business Library xCBL 2.0. The EUFI thus identifies the data format you seek and can manipulate or read, and is an OPTIONAL argument

[elti]—The ECCMA Language Translation Identifier, a valid Sequence Identifier from the ECCMA Language Translation Schema (ELTS) that identifies the desired language for the web pages that are returned. The ELTI is an OPTIONAL argument.

[distunit]—The units of measurement that should be returned as the distance value. Either “MI” for miles or “KM” for kilometers. This argument is only used on conjunction with a geographical search (i.e. lat/long or city/state/country). It is OPTIONAL and will default to miles for a geographical search if it is not passed.

[maxdist]—The maximum distance from the user. This specifies the maximum allowable distance that a trading partner can be from you. This argument is only used on conjunction with a geographical search (i.e. lat/long or city/state/country). The maximum distance argument is OPTIONAL.

[maxrec]—The maximum number of records that WHOSELLS SHOULD return. The maximum record argument is OPTIONAL and if not specified, its default maximum is 1,000.

[skip]—The skip argument is OPTIONAL and controls which records (out of your maxrec return) you receive. The skip argument lets you specify several methods of traversing those records. One method is to randomize results. That is, instead of returning the specified number of records sorted from closest to farthest, the server will return those records as a random sample of vendors within the specified distance range. Still another method is to skip a specified range of records. For example, suppose you ask for a maxrec of 100 within a specified distance range but the server 502 reports that 1000 records exist. Rather than pull a new query that returns records you've already seen, you can instead specify that you want to skip the first 100, or 200, or 300. This argument is only used on conjunction with a geographical search (i.e. lat/long or city/state/country).

In response, the server returns an XML document in the following format:

<?xml version=“1.0” encoding=“UTF-8”?>
<ResolvenetWhosellsResponse

xmlns:xsi=“http://www.w3.org/2000/10/XMLSchema-instance”
xsi:noNamespaceSchemaLocation=“ http://www.ResolveNet.net/

```
XMLSchemas/WhosellsSchema.xsd”>
  <Results>
  <TotalRecordsFound>2</TotalRecordsFound>
  <RecordsSkipped>0</RecordsSkipped>
  <Result>
    <URL ELTI=“000001” EUFI=“900041” EUTI=“000001”>
    http://www.myCompany.com</URL>
    <GBI>1234-2345-6789</GBI>
    <GLI>3456-2345-1234</GLI>
    <Distance Units=“MI”>35</Distance>
  </Result>
  <Result>
    <URL ELTI=“000001” EUFI=“900041” EUTI=“000001”>
    http://www.yourCompany.com</URL>
    <GBI>1234-2345-6789</GBI>
    <GLI>3456-2345-1234</GLI>
    <Distance Units=“MI”>56</Distance>
  </Result>
  </Results>
</ResolvenetWhosellsResponse>
```

For Each <Result> element, the sub elements and attributes are described as follows:

XML Element <URL>—The Uniform Resource Locator of the vendor's page or server from which it transacts business.

XML Attribute [EUTI]—The ECCMA URL Type Identifier, the Sequence Identifier from the ECCMA URL Type Schema (EUTS) that identifies the trading partner's URL type, e.g., home page, product catalog, price catalog, etc.

XML Attribute [EUFI]—The ECCMA URL Format Identifier, the Sequence Identifier from the ECCMA URL Format Schema (EUFS) that identifies the data type of the web page identified by a URL.

XML Attribute [ELTI]—The ECCMA Language Translation Identifier, the Sequence Identifier from the ECCMA Language Translation Schema (ELTS) that identifies the language of the web page identified by a URL.

XML Element <GBI>—The Global Business Identifier. The Global Business Identifier (GBI) is a twelve-digit, unique identifier that both uniquely identifies a trading entity and (can) point to all other business identifiers assigned to the same. In global electronic commerce systems (such as those maintained by ResolveNet), the GBI serves as a pointer to all business identifiers associated with a specified trading partner. To learn more about GBI, please visit ResolveNet at http://www.ResolveNet.net.

XML Element <GLI>—The Global Location Identifier(GLI). The GLI is a twelve-digit, unique identifier that identifies the trading partner's mailing address and location (i.e. long, lat). For more information on the GLI, please visit the ResolveNet GLI page at http://www.ResolveNet.net.

XML Element <Distance>—The distance between the returned vendor and the user, which WHOSELLS will return either in kilometers or miles based on the user's preference.

WHOSELLS Query and Response Examples

Users query the Whosells server 502 database using a standard URL with a query string.

Syntax: http.//whosells.resolvenet.net?egci=######.######&lat=+###.##

&long=−###.##&city=$$$$$$$$$&state=$$&euti=######&eufi=######&

elti=######&distunit=MI&maxdist=######&maxrec=####&skip=####

A typical query looks like this:

http://whosells.resolvenet.net?egci=009286.010644&lat=+34.03

&long=−118.19&euti=000001&eufi=000001&elti=000001&distance=500

&max=10&skip=0

(Note: the “lat” and “long”0 name/value pair MAY be replaced with the “city”, “state”, “country” name/value combination, or all geographical information MAY be omitted if location is of no concern.)

The above query consist of the following values:

| | |
|---|---|
| egci | 009286.010644 |
| | (009286 is the ECCMA Global Commodity Identifier |
| | for Computer Services, 010644 is the Business Type |
| | Identifier (BTI) for Retail) |
| lat | +34.03 |
| long | −118.19 |
| euti | 000001 (Home pages) |
| eufi | 000001 (HTML) |
| elti | 000001 (English) |
| distunit | Miles |
| maxdist | 500 (500 miles) |
| maxrec | 10 (only 10 records) |
| skip | Start with the first record |

As such, the aforementioned query makes the follow definitive statement: “I want all vendors within 500 miles of Los Angeles that deal in Computer Services who have a home page formatted in English and HTML, and I only want the first ten records.”

The server 502 would then respond with one or more <Result> records in XML format as follows:

<?xml version=“1.0” encoding=“UTF-8”?>
<ResolvenetWhosellsResponse

xmlns:xsi=“http://www.w3.org/2000/10/XMLSchema-instance”
xsi:noNamespaceSchemaLocation=“http://www.ResolveNet.net/
XMLSchemas/whosellsSchema.xsd”>

```
  <Results>
  <TotalRecordsFound>1</TotalRecordsFound>
  <RecordsSkipped>0</RecordsSkipped>
  <Result>
    <URL  EUTI=“000001”  EUFI=“000001”
```

ELTI=“000001”>http://www.Company.com</URL>

```
    <GBI>1234-1345-6789</GBI>
    <GLI>3456-2345-1234</GLI>
    <Distance Units=“Miles”>35</Distance>
  </Result>
  </Results>
</ResolvenetWhosellsResponse>
```

This response reports the following information:

| | |
|---|---|
| URL | http://www.Company.com |
| EUTI | 000001 (Home Page) |
| EUFI | 000001 (HTML) |
| ELTI | 000001 (English) |
| GBI | 1234-1345-6789 |
| GLI | 3456-2345-1234 |
| Distance | 35 (35 miles from Los Angeles) |

A similar query and response based on the city/state/country combination would appear as follows.

Query:

http://whosells.resolvenet.net?egci=009286.010644&city=Boston &state=MA&country=us&euti=000001&eufi=000001&elti=000001&

distance=500&max=10&skip=0

Response:

<?xml version=“1.0” encoding=“UTF-8”?>
<ResolvenetWhosellsResponse

xmlns:xsi=“http://www.w3.org/2000/10/XMLSchema-instance”
xsi:noNamespaceSchemaLocation=“http://www.ResolveNet.net/
XMLSchemas/whosellsSchema.xsd”>

```
  <Results>
  <TotalRecordsFound>1</TotalRecordsFound>
  <RecordsSkipped>0</RecordsSkipped>
  <Result>
    <URL ELTI=“000001” EUFI=“900041” EUTI=“000001”>
    http://www.myCompany.com</URL>
    <GBI>1234-2345-6789</GBI>
    <GLI>3456-2345-1234</GLI>
    <Distance Units=“MI”>35</Distance>
    <City>Cambridge</City>
    <State>MA</State>
    <Country>US</Country>
  </Result>
  </Results>
</ResolvenetWhosellsResponse>
```

In many cases, output may well be more extensive. Many businesses will register more than one EUTI or EUFI and a resulting vendor record would contain multiple results.

It can be appreciate that various suppliers 510 can communicate with the server 502 utilizing the whosells protocol to supply and validate their records 300. It is also to be understood that upon returning favorable results to a client 508, the client 508 can immediately access the supplier 510 and their information through the network 506, such as the Internet.

While the invention has been shown and described with reference to certain preferred embodiment thereof, it will be understood by those skilled in the art that various changes in form and detail may be made therein without departing from the spirit and scope of the invention as defined by the appended claims.

What is claimed is:

1. A method for performing electronic commerce, comprising the steps of:
receiving a query including at least one code-specific and/or predetermined value over a network; and
querying a database connected to said network to find at least one result related to said code-specific and/or predetermined value.

2. A method for performing electronic commerce as in claim 1, further comprising the step of returning said at least one found result to a client associated with said query.

3. A method for performing electronic commerce as in claim 1, wherein the at least one pre-determined value is a latitude and longitude location value.

4. A method for performing electronic commerce as in claim 1, wherein the at least one code-specific value is indicative of a at least one code selected from the group consisting of a sequence identifier, a URL type identifier, a URL format identifier, and a language translation identifier.

5. A method for performing electronic commerce as in claim 2, wherein the at least one found result includes information regarding a particular vendor.

6. A method for performing electronic commerce as in claim 5, wherein the at least one pre-determined value is a value indicative of a maximum distance between said vendor and said client.

7. A method for performing electronic commerce as in claim 1, wherein said step of returning said at least one found result further includes the step of returning a Uniform Resource Locator (URL) corresponding to a network location associated with a particular vendor.

8. A method for performing electronic commerce as in claim 1, wherein said step of returning said at least one found result further includes the step of returning a global business identifier identifying a business category corresponding to a particular vendor.

9. A method for performing electronic commerce as in claim 1, wherein said step of returning said at least one found result further includes the step of returning a global location identifier identifying the location of a particular vendor.

10. A method for performing electronic commerce as in claim 1, wherein said step of returning said at least one found result further includes the step of returning a distance between a latitude and longitude value and a particular vendor.

11. A method for performing electronic commerce as in claim 1, further comprising the steps of:
receiving information from a trading vendor relating to said vendor's products and/or services;
formatting said information into a format including at least one data segment;
tagging said at least one data segment using at least one code; and
storing said at least one tagged data segment in said database.

12. A method for performing electronic commerce as in claim 11, wherein said at least one code is selected from the group consisting of the Universal Standard Products and Services Classification (UNSPSC) code, a global business identifier, and a global location identifier.

13. A system for performing electronic commerce comprising:
a server coupled to a network for receiving a query and searching vendor information, wherein the query includes at least one code-specific and/or predetermined value; and
a database accessible by said server and storing said vendor information, wherein said vendor information is tagged with at least one identifier.

14. A system for performing electronic commerce as in claim 13, wherein said at least one identifier is a global business identifier.

15. A system for performing electronic commerce as in claim 13, wherein said at least one identifier is a global location identifier.

16. A system for performing electronic commerce as in claim 13, wherein said vendor information includes at least a Uniform Resource Locator (URL), a URL type identifier, a URL format identifier, and a language translation identifier.

17. A system for performing electronic commerce, comprising:
means for receiving a query including at least one code-specific and/or predetermined value over a network; and
means for querying a database connected to said network to find at least one result related to said code-specific and/or predetermined value.

18. A system for performing electronic commerce as in claim 17, further comprising means for returning said at least one found result to a client associated with said query.

19. A system for performing electronic commerce as in claim 17, wherein the at least one pre-determined value is a latitude and longitude location value.

20. A system for performing electronic commerce as in claim 17, wherein the at least one code-specific value is indicative of at least one code selected from the group consisting of a sequence identifier, a URL type identifier, a URL format identifier and a language translation identifier.

21. A system for performing electronic commerce as in claim 18, wherein the at least one found result includes information regarding a particular vendor.

22. A system for performing electronic commerce as in claim 21, wherein the at least one pre-determined value is a value indicative of a maximum distance between said vendor and said client.

23. A system for performing electronic commerce as in claim 17, wherein said at least one found result includes a Uniform Resource Locator (URL) corresponding to a network location associated with a particular vendor.

24. A system for performing electronic commerce as in claim 17, wherein said at least one found result includes a global business identifier identifying a business category corresponding to a particular vendor.

25. A system for performing electronic commerce as in claim 17, wherein said at least one found result includes a global location identifier identifying the location of a particular vendor.

26. A system for performing electronic commerce as in claim 17, wherein said at least one found result includes a distance between a latitude and longitude value and a particular vendor.

27. A system for performing electronic commerce as in claim 17, further comprising:
means for receiving information from a trading vendor relating to said vendor's products and/or services;
means for formatting said information into a format including at least one data segment;
means for tagging said at least one data segment using at least one code; and
means for storing said at least one tagged data segment in said database.

28. A system for performing electronic commerce as in claim 27, wherein said at least one code is selected from the group consisting of the Universal Standard Products and Services Classification (UNSPSC) code, a global business identifier, and a global location identifier.

29. A method for performing electronic commerce, comprising the steps of:
receiving information from a trading vendor relating to said vendor's products and/or services;
formatting said information into a format including at least one data segment;
tagging said at least one data segment using at least one code; and
storing said at least one tagged data segment in a database.

30. A method for performing electronic commerce as in claim 29, wherein said at least one code is selected from the group consisting of the Universal Standard Products and Services Classification (UNSPSC) code, a global business identifier, and a global location identifier.
